(19) United States
(12) Patent Application Publication
(10) Pub. No.: US 2026/0222899 A1
(43) Pub. Date: Jul. 30, 2026

(54) MANAGING WI-FI SLICING FOR ENTERPRISE TRAFFIC (WISE) IN A WIRELESS NETWORK

(71) Applicant: Samsung Electronics Co., Ltd., Suwon-si (KR)

(72) Inventors: Madhan Raj KANAGARATHINAM, Bangalore (IN); Junhak LIM, Suwon-si (KR); Srihari SRIRAM, Bangalore (IN)

(21) Appl. No.: 19/578,274

(22) Filed: Mar. 25, 2026

Related U.S. Application Data
(63) Continuation of application No. PCT/KR2024/015525, filed on Oct. 14, 2024.

(30) Foreign Application Priority Data
Oct. 27, 2023 (IN) 202341073168
Sep. 12, 2024 (IN) 2023 41073168

(51) Int. Cl. H04W 28/02

(52) U.S. Cl. CPC H04W 28/0268

(57) ABSTRACT

A method for managing WiSE in a wireless network is provided. The method includes receiving, by a station, an input traffic from a plurality of applications associated with the station, identifying, by the station, an enterprise traffic within the input traffic received from the plurality of applications associated with the station, wherein the enterprise traffic is related to at least one enterprise application of the plurality of applications associated with the station, classifying, by the station, the enterprise traffic into one or more access categories, configuring, by the station, at least one of a Layer 2 (L2) header, a Layer 3 (L3) header, a Layer 4 (L4) header, or an application layer header in data packets of the enterprise traffic based on the access categories, and transmitting, by the station, the configured enterprise traffic to an Access Point (AP) to provide a communication service with enhanced Quality of Service (QoS).

### CROSS-REFERENCE TO RELATED APPLICATION(S

This application is a continuation application, claiming priority under 35 U.S.C. § 365(c), of an International application No. PCT/KR2024/015525, filed on October 14, 2024, which is based on and claims the benefit of an Indian Provisional patent application number 202341073168, filed on October 27, 2023, in the Indian Office of Intellectual Property, and of an Indian Complete patent application number 202341073168, filed on September 12, 2024, in the Indian Office of Intellectual Property, the disclosure of each of which is incorporated by reference herein in its entirety.

### BACKGROUND

### 1. Field

The disclosure relates to a wireless network system. More particularly, the disclosure relates to managing wireless fidelity (Wi-fi) slicing for enterprise traffic (WiSE) in a wireless network.

### 2. Description of Related Art

The Wi-Fi Multimedia (WMM) is a Quality of Service (QoS) feature in wireless network systems designed to enhance network performance by prioritizing traffic based on its type. This prioritization ensures that time-sensitive data, such as voice, video, and gaming traffic, receives higher priority over less critical traffic like file downloads or web browsing. Consequently, WMM improves the overall performance of multimedia applications, particularly in congested or busy wireless networks.

FIG. 1A is a schematic diagram that illustrates access categories in a Wi-Fi Multimedia system according to the related art.

Referring to FIG. 1A, a component of WMM is the categorization of network traffic into four access categories: Voice (AC_VO)(101), Video (AC_VI)(103), Best-Effort (AC_BE)(105), and Background (AC_BK)(107). The Voice access category, having the highest priority, is primarily used for Voice over Internet Protocol (VoIP) and other latency-sensitive applications. The Video access category, with the second-highest priority, is suitable for video streaming. The Best Effort access category, with default priority, handles regular data traffic such as web browsing. Lastly, the Background access category, with the lowest priority, is used for non-urgent traffic like file transfers.

FIG. 1B is a schematic diagram that illustrates wireless fidelity multimedia access category (WMM AC) timing for different access categories, according to the related art.

Referring to FIG. 1B, the Wi-Fi networks carry a heavy load of real-time data applications, voice and video, which means low tolerance for latency, packet loss, and jitter. The existing techniques enable Wi-Fi networks to optimize performance by managing the requirements of different types of traffic and ensuring the user experience in home, enterprise, and hotspot environments. Further the QoS functionality is added in the Wi-Fi networks. Hence, using the WMM, network administrators and residential users can assign higher priority to real-time traffic such as voice and video while assigning other data traffic to either best-effort or background priority levels. Further to WMM, WMM-Power Save is introduced to improve the battery life of mobile devices and increase the efficiency of transmission of voice calls over Wi-Fi networks.

The WMM-Admission Control further improves the performance of Wi-Fi networks for real-time data such as voice and video. It enhances the reliability of applications in progress by preventing oversubscription of bandwidth. WMM-Admission Control enhances the prioritization of traffic using the access categories introduced by WMM (i.e., voice, video, best-effort data, and background data) by employing bandwidth management to take into account network load and channel conditions. This ensures that high-priority traffic, such as voice and video, is transmitted with minimal delay and packet loss, thereby maintaining the quality of service required for these applications. By preventing the wireless network from becoming oversaturated, WMM-Admission Control helps maintain a stable and efficient network environment, which is crucial for both home and enterprise settings.

FIGS. 2A and 2B are graphical representations that illustrate three prioritized data streams that behave with WMM and without WMM, according to the related art.

Referring to FIGS. 2A and 2B, WMM specifies a protocol used by the AP to communicate the policy to QoS-enabled clients and by the clients to send transmit requests. WMM does not itself set the priority policy; that is performed by the application or device that is sending the data. FIG. 2A shows WMM maintaining a smooth 10 Mbps rate for a video stream when data streams with lower priority cause total bandwidth to be exceeded. The video stream is left with as much bandwidth as it needs, while the lower-priority streams are slowed to provide the required bandwidth. This demonstrates how WMM can effectively manage network resources to ensure that high-priority traffic receives the necessary bandwidth to function correctly.

FIG. 2B illustrates the result when WMM is not in effect, indicating that all streams drop back in speed when the third stream again causes available bandwidth to be exceeded. Without WMM, the wireless network cannot prioritize traffic effectively, leading to a degradation in the quality of service for all types of traffic. This scenario highlights the importance of WMM in maintaining the performance and reliability of Wi-Fi networks, in environments with multiple types of traffic competing for bandwidth.

FIG. 3 is a schematic diagram that illustrates a traffic handling mechanism in a wireless network, according to the related art.

Referring to FIG. 3, an application layer (301) generates input traffic from one or more applications running at a station. Below the application layer, the input traffic is split into four queues associated with each of the access categories based on the priority of the input traffic. Particularly, the input traffic is added to a queue of the voice access category (303) when the input traffic is voice traffic. Similarly, the input traffic is added to the queue of the video access category (305) when the input traffic is video traffic. Also, the input traffic is added to the queue of best-effort (307) when the input traffic is given a default priority for Wi-Fi service. Similarly, the input traffic is added to the queue of the background access category when the input traffic is given the least priority for accessing the Wi-Fi service.

Further, each queue has a set of parameters that control the amount of time for which the traffic needs to wait before being sent for accessing the Wi-Fi service. Some of the key parameters are Arbitration Interframe Space (AIFS), which indicates a waiting time before transmission starts; CWmin, which indicates a minimum contention window, the smallest window size for random backoff; CWmax, which indicates the maximum contention window, the largest window size for random backoff; and Transmission Opportunity (TXOP), which indicates the time limit during which the device can send multiple frames in one go. Further, when multiple queues attempt to access the same time slot, the input traffic with the highest priority is given access first. Finally, the highest priority traffic is transmitted towards the Wi-Fi network for accessing the Wi-Fi service. This mechanism ensures that high-priority traffic, such as voice and video, is transmitted with minimal delay and packet loss, thereby maintaining the quality of service required for these applications.

The above information is presented as background information only to assist with an understanding of the disclosure. No determination has been made, and no assertion is made, as to whether any of the above might be applicable as prior art with regard to the disclosure.

### SUMMARY

Despite the advantages provided by wireless fidelity multimedia (WMM), several issues persist in the existing technology. For instance, traffic from various applications, such as live video streaming, personal video calls, enterprise video calls, and gaming traffic, is grouped under the same Video access category. When such traffic reaches the Access Point (AP), it is all given the same priority. This uniform prioritization fails to distinguish between different video applications, which can be problematic in enterprise environments where enterprise applications require additional priority for smooth operations.

In current systems, wireless fidelity (Wi-Fi) APs traditionally use domain name system (DNS)-based or internet protocol (IP)-based mechanisms to prioritize enterprise traffic. However, with the advent of secured DNS and other methodologies, it has become challenging for APs to reliably recognize and prioritize enterprise traffic. Further, a station or non-AP client often has better awareness of the context of enterprise traffic than the AP, yet the AP is responsible for prioritizing the received traffic.

As WMM prioritization is based on access categories rather than specific applications, it may not adequately prioritize traffic from enterprise applications. This gap in the current system highlights the need for improved solutions to address these disadvantages, issues, or other shortcomings, or at least to provide a useful alternative.

Aspects of the disclosure are to address at least the above-mentioned problems and/or disadvantages and to provide at least the advantages described below. Accordingly, an aspect of the disclosure is to provide to a wireless network system and managing wireless fidelity (Wi-fi) slicing for enterprise traffic (WiSE) in a wireless network.

Additional aspects will be set forth in part in the description which follows and, in part, will be apparent from the description, or may be learned by practice of the presented embodiments.

In accordance with an aspect of the disclosure, a method for managing WiSE in a wireless network is provided. The method includes receiving, by a station, an input traffic from a plurality of applications associated with the station. Further, the method includes identifying, by the station, an enterprise traffic within the input traffic received from the plurality of applications associated with the station, wherein the enterprise traffic is related to at least one enterprise application of the plurality of applications associated with the station. Further, the method includes classifying, by the station, the enterprise traffic into one or more access categories. Further, the method includes configuring, by the station, at least one of a Layer 2 (L2) header, a Layer 3 (L3) header, a Layer 4 (L4) header, or an application layer header in data packets of the enterprise traffic based on the access categories. Further, the method includes transmitting, by the station, the configured enterprise traffic to an Access Point (AP) to provide a communication service with enhanced Quality of Service (QoS).

In an embodiment, the method further includes receiving, by the AP, the input traffic from the station The input traffic includes the configured enterprise traffic and non-enterprise traffic. The method further includes detecting, by the AP, the configured enterprise traffic within the input traffic based on the configured at least one of the L2 header, the L3 header, the L4 header, or the application layer header in the data packets of the enterprise traffic. The method further includes prioritizing, by the AP, the detected enterprise traffic over the non-enterprise traffic to provide the communication service for the enhanced QoS to the station. The method further includes restoring, by the AP, at least one of a legacy L2 header, a legacy L3 header, a legacy L4 header, or a legacy application layer header to the prioritized enterprise traffic.

In an embodiment, the identifying, by the station, of the enterprise traffic within the input traffic received from the plurality of applications includes determining, by the station, a unique identifier (UID) of the plurality of applications and a context related to the plurality of applications. The identifying, by the station, of the enterprise traffic within the input traffic received from the plurality of applications further includes identifying, by the station, the enterprise traffic associated with the enterprise application based on the UID and the context related to the at least one enterprise application of the plurality of applications associated with the station.

In an embodiment, the configuring, by the station, of the L2 header in the data packets of the enterprise traffic based on the access categories includes setting, by the station, a Differentiated Service Code Point (DSCP) value in a Type of Service (ToS) field in the L3 header that is indicative of the enterprise traffic within the input traffic. The configuring, by the station, of the L2 header in the data packets of the enterprise traffic based on the access categories further includes sending, by the station, at least one of a Mirrored Stream Classification Service (MSCS) request message or a Stream Classification Service (SCS) request message to the AP for confirming presence of the enterprise traffic.

In an embodiment, the configuring, by the station, of the L3 header in the data packets of the enterprise traffic based on the access categories includes setting, by the station, a Differentiated Service Code Point (DSCP) value in a Type of Service (ToS) field in the L3 header that is indicative of the enterprise traffic within the input traffic.

In an embodiment, the configuring, by the station, of the L2 header in the data packets of the enterprise traffic based on the access categories includes setting, by the station, a two-bit value in a User Priority (UP) control field in the L2 header that is indicative of the enterprise traffic within the input traffic.

In an embodiment, the configuring, by the station, of the L4 header in the data packets of the enterprise traffic based on the access categories includes modifying, by the station, Transmission Control Protocol (TCP) options in the L4 header that are indicative of the enterprise traffic within the input traffic.

In an embodiment, the configuring, by the station, of the application layer header in the data packets of the enterprise traffic based on the access category includes adding, by the station, a new header in the application layer that comprises one or more fields which are indicative of the enterprise traffic within the input traffic.

In an embodiment, the detecting, by the AP, of the configured enterprise traffic within the input traffic based on the configured at least one of the L2 header, the L3 header, the L4 header, or the application layer header in the data packets of the enterprise traffic includes performing, by the AP, at least one of identifying a Differentiated Service Code Point (DSCP) value in the L3 header that is indicative of the enterprise traffic, or receiving at least one of a Mirrored Stream Classification (MSCS) request message or a Stream Classification Service (SCS) request message that indicates the configuring of the DSCP value in the L3 header; or identifying a two-bit value in a User Priority (UP) control field in the L2 header that is indicative of the enterprise traffic, or detecting modification performed in the L4 header that is indicative of the enterprise traffic, or identifying the application layer header that is indicative of the enterprise traffic. The detecting, by the AP, of the configured enterprise traffic within the input traffic based on the configured at least one of the L2 header, the L3 header, the L4 header, or the application layer header in the data packets of the enterprise traffic further includes, based on the performing, detecting, by the AP, the configured enterprise traffic within the input traffic based on the configured at least one of the L2 header, the L3 header, the L4 header and the application layer header in data packets of the enterprise traffic.

In an embodiment, the one or more access categories are voice, video, best-effort, Time-Sensitive Networking (TSN), and background.

In accordance with another aspect of the disclosure, a station in Wi-Fi system for managing WiSE in a wireless network is provided. The station includes an input output (I/O) interface configured to receive and transmit a signal. Further, the station includes one or more processors communicatively coupled to the I/O interface. Further, the station includes memory, including one or more storage media, storing one or more computer programs, the memory being communicatively coupled to the I/O interface and the one or more processors. Further, the station includes a WiSE controller communicatively coupled to the I/O interface, the one or more processors, and the memory. The one or more computer programs include computer-executable instructions that, when executed by the one or more processors individually or collectively, cause the WiSE controller to receive an input traffic from a plurality of applications associated with the station. Further, the computer-executable instructions, when executed by the one or more processors individually or collectively, cause the WiSE controller to identify an enterprise traffic within the input traffic received from the plurality of applications associated with the station, wherein the enterprise traffic is related to at least one enterprise application of the plurality of applications associated with the station. Further, the computer-executable instructions, when executed by the one or more processors individually or collectively, cause the WiSE controller to classify the enterprise traffic into one or more access categories. Further, the computer-executable instructions, when executed by the one or more processors individually or collectively, cause the WiSE controller to configure at least one of a Layer 2 (L2) header, a Layer 3 (L3) header, a Layer 4 (L4) header, or an application layer header in data packets of the enterprise traffic based on the access categories. Further, the computer-executable instructions, when executed by the one or more processors individually or collectively, cause the WiSE controller to transmit the configured enterprise traffic to an Access Point (AP) to provide a communication service with enhanced Quality of Service (QoS).

In an embodiment, the AP includes a second I/O interface configured to receive and transmit the signal. The AP further includes second one or more processors communicatively coupled to the second I/O interface. The AP further includes second memory, including second one or more storage media, storing second one or more computer programs, the second memory being communicatively coupled to the second I/O interface and the second one or more processors. The AP further includes a second WiSE controller communicatively coupled to the second I/O interface, the second one or more processors, and the second memory. The second one or more computer programs include second computer-executable instructions that, when executed by the second one or more processors individually or collectively, cause the second WiSE controller to receive the input traffic from station. The input traffic includes the configured enterprise traffic and non-enterprise traffic. Further, the second computer-executable instructions, when executed by the second one or more processors individually or collectively, cause the second WiSE controller to detect the configured enterprise traffic within the input traffic based on the configured at least one of the L2 header, the L3 header, the L4 header, or the application layer header in the data packets of the enterprise traffic. Further, the second computer-executable instructions, when executed by the second one or more processors individually or collectively, cause the second WiSE controller to prioritize the detected enterprise traffic over the non-enterprise traffic to provide the communication service for the enhanced QoS to the station. Further, the second computer-executable instructions, when executed by the second one or more processors individually or collectively, cause the second WiSE controller to restore at least one of a legacy L2 header, a legacy L3 header, a legacy L4 header, or a legacy application layer header to the prioritized enterprise traffic.

In an embodiment, the one or more computer programs include an artificial intelligence (AI) model including at least one of a neural network model, an eXtreme Gradient Boosting (XGBoost) model, or a transformer model.

In an embodiment, the AI model is a trained AI model that has been trained on historical data.

In accordance with another aspect of the disclosure, one or more non-transitory computer-readable storage media storing one or more computer programs including computer-executable instructions that, when executed by one or more processors individually or collectively of a station in a wireless-fidelity (Wi-Fi) system for managing Wi-Fi Slicing for Enterprise Traffic (WiSE) in a wireless network, cause the station to perform operations. The operations include receiving, by the station, an input traffic from a plurality of applications associated with the station. Further, the operations include identifying, by the station, an enterprise traffic within the input traffic received from the plurality of applications associated with the station. The enterprise traffic is related to at least one enterprise application of the plurality of applications associated with the station. Further, the operations include classifying, by the station, the enterprise traffic into one or more access categories. Further, the operations include configuring, by the station, at least one of a Layer 2 (L2) header, a Layer 3 (L3) header, a Layer 4 (L4) header, or an application layer header in data packets of the enterprise traffic based on the access categories. Further, the operations include transmitting, by the station, the configured enterprise traffic to an Access Point (AP) to provide a communication service with enhanced Quality of Service (QoS).

The principal aspect of the embodiments herein is to manage WiSE in a wireless network. By implementing WiSE, enterprises can experience enhanced performance and productivity, as the wireless network can dynamically allocate resources to meet the specific needs of different types of traffic.

Another aspect of the disclosure is to provide a Station (STA) guaranteed and AP assisted method to categorize and prioritize the enterprise traffic for smooth business operation. This method involves the STA identifying the type of traffic and communicating this information to the AP, which then assists in managing the traffic flow, thereby maintaining the QoS required for various network operations.

Yet another aspect of the disclosure is to distinguish between the enterprise traffic and non-enterprise traffic.

Yet another aspect of the disclosure is to identify different classes of traffic, such as Time-Sensitive Networking (TSN), Voice, Video, Best-effort, and Background, by the UE among the identified enterprise traffic. By classifying the traffic into these categories, the wireless network can apply specific QoS policies tailored to the requirements of each class.

Yet another aspect of the disclosure is to mark the identified enterprise traffic using a Differentiated Service Code Point (DSCP) value to indicate the presence of enterprise traffic for the AP.

Yet another aspect of the disclosure is to convert traffic from pool B to pool A by the AP, so that the packets are not dropped by the middlebox later. By ensuring that the traffic is correctly classified and prioritized, the AP can prevent packet loss and ensure that the enterprise applications run smoothly.

Yet another aspect of the disclosure is to prioritize the enterprise traffic among the non-enterprise traffic by identifying the marked DSCP value, thereby providing a better QoS for enterprise applications, ensuring that they run efficiently and without interruption.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a schematic diagram that illustrates access categories in a Wi-Fi Multimedia system according to the related art;

FIG. 1B is a schematic diagram that illustrates wireless fidelity multimedia access category (WMM AC) timing for different access categories, according to the related art;

FIGS. 2A and 2B are graphical representations that illustrate three prioritized data streams that behave with WMM and without WMM, according to the related art;

FIG. 3 is a schematic diagram that illustrates a traffic handling mechanism in a wireless network, according to the related art;

FIG. 4A is a block diagram that illustrates a Wi-Fi system for managing WiSE in a wireless network, according to an embodiment of the disclosure;

FIG. 4B is a block diagram that illustrates a station for managing WiSE in a wireless network, according to an embodiment of the disclosure;

FIG. 4C is a block diagram that illustrates an access point for managing WiSE in a wireless network, according to an embodiment of the disclosure;

FIG. 5 is a schematic diagram that illustrates access categories in WMM, according to an embodiment of the disclosure;

FIGS. 6A and 6B are flow diagrams that illustrates a method for managing WiSE in a wireless network, according to various embodiments of the disclosure;

FIG. 7 is a schematic diagram that illustrates a method of mangling of DSCP value in the Layer 3 header of data packets to indicate the presence of enterprise traffic, according to an embodiment of the disclosure;

FIG. 8 is a schematic diagram that illustrates a method of multi-level DSCP mapping, according to an embodiment of the disclosure;

FIG. 9A is a schematic diagram that illustrates sending multi stream classification service (MSCS)/stream classification service (SCS) messages indicating the presence of enterprise traffic, according to an embodiment of the disclosure;

FIG. 9B is a schematic diagram that illustrates a method of identifying and prioritizing enterprise traffic at an access point, according to an embodiment of the disclosure;

FIGS. 10A and 10B are schematic diagrams that illustrate an example scenario of prioritizing the enterprise traffic at the access point, according to various embodiments of the disclosure;

FIG. 11A is a schematic diagram that illustrates an Internet Protocol (IP) header structure indicating DSCP value in the Type of Service (ToS) field for data packets of non-enterprise traffic, according to an embodiment of the disclosure; and

FIG. 11B is a schematic diagram that illustrates an IP header structure indicating DSCP value in the ToS field for data packets of enterprise traffic, according to an embodiment of the disclosure.

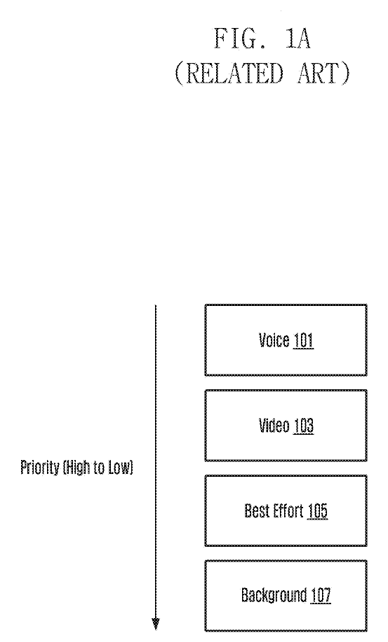

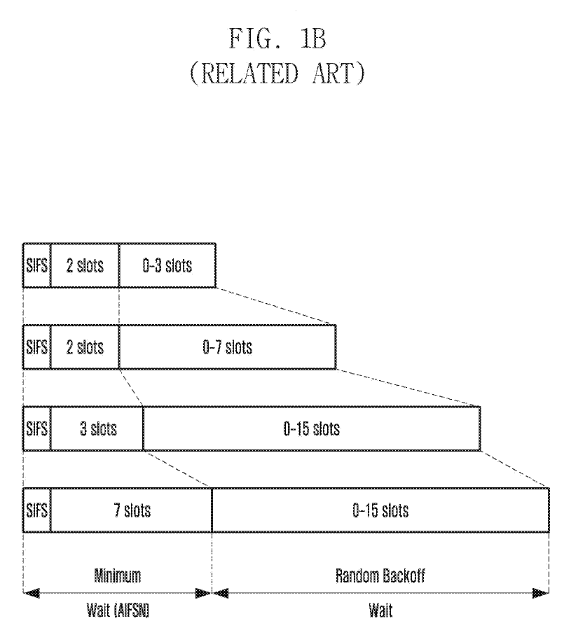

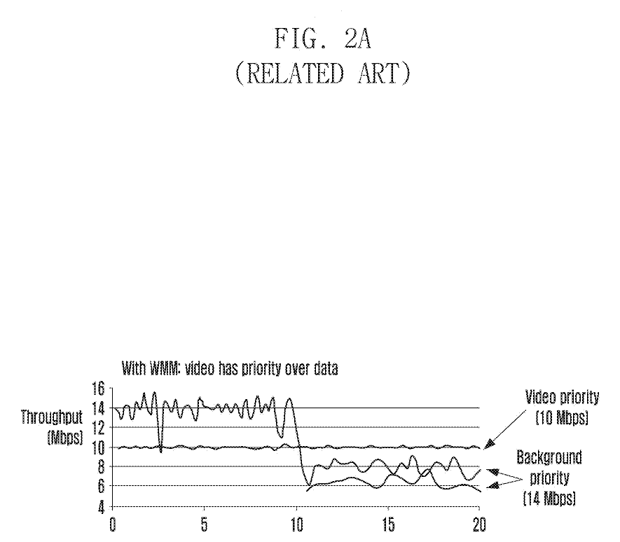

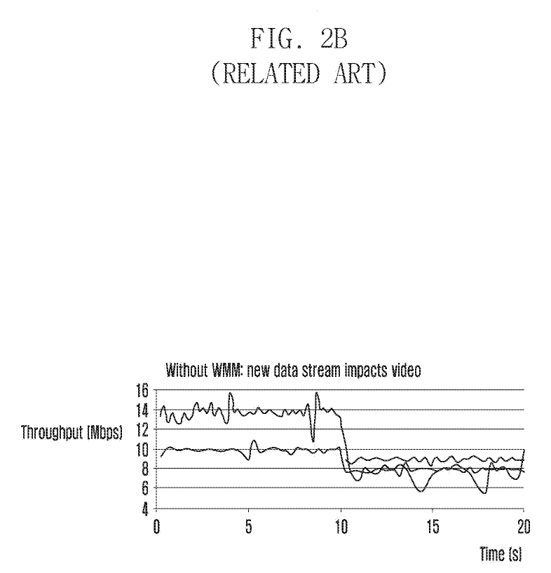

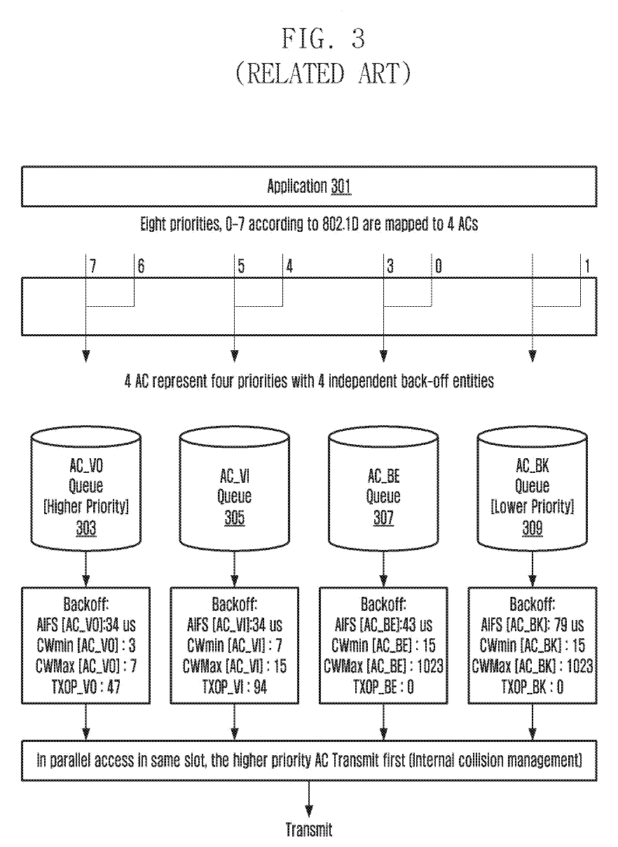

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms "first," "second," etc. are used herein to describe various elements, these elements are not limited by these terms. These terms are generally used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

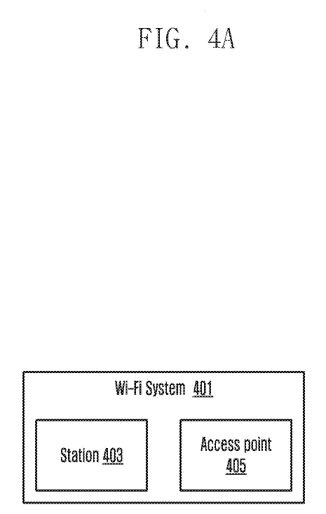

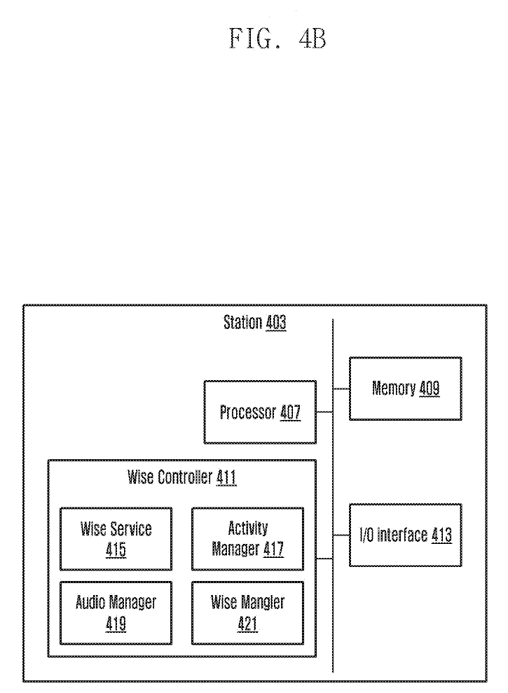

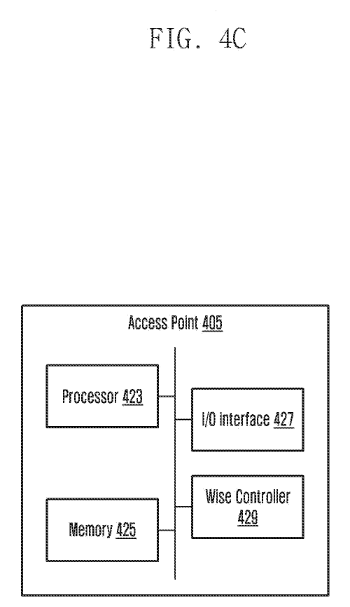

FIG. 4A is a block diagram that illustrates a Wi-Fi system for managing WiSE in a wireless network according to an embodiment of the disclosure.

The Wi-Fi system (401) includes a station (403) and an AP (405). The Wi-Fi system (401) refers to a wireless communication framework that allows devices called stations (STAs) (403) to connect to a network through a central device known as the AP (405). The AP (405) acts as a bridge between the wireless stations and the broader wired network (such as the internet), facilitating the transmission of data over radio waves.

The station (403) is a device with a wireless network interface that connects to a Wi-Fi network. For example, the station can be at least one of a laptop, smartphone, tablet, desktop, and the like. The AP is a device that allows wireless stations to connect to a wired network such as a Local Area Network (LAN) or the internet. The AP (405) provides a central hub for wireless communication by broadcasting a Wi-Fi signal that stations (403) can connect to. Thus, the AP (405) manages the communication between the station (403) and the wireless network.

The stations (403) can have one or more applications running simultaneously. The station (403) captures the input traffic from the one or more applications running. The one or more applications can be at least one of an enterprise application and a non-enterprise application. Enterprise applications are complex software systems designed to meet the needs of large organizations. These applications handle a wide range of functions such as customer relationship management (CRM), supply chain management, human resources, and enterprise resource planning (ERP). They are built to support large volumes of data, multiple users, and integrate with other systems within the organization. Enterprise applications often require significant customization, ongoing maintenance, and support from internet technology (IT) professionals to ensure they function seamlessly within the organization's infrastructure. For example, the one or more enterprise applications can include but are not limited to email applications, Voice over IP calls (VoIP), video conferencing applications, security applications, and cloud-based applications. Further, non-enterprise applications are software programs designed for individual or small-scale use. These applications are typically straightforward, easy to install, and cater to personal productivity, entertainment, or small business needs. Examples include mobile apps like social media platforms, personal finance tools, and simple project management software. They generally require minimal configuration and can often be downloaded and used immediately without extensive technical support. For example, the non-enterprise applications can include but are not limited to gaming applications, social media applications, streaming applications, messaging applications, e-commerce applications, and entertainment applications.

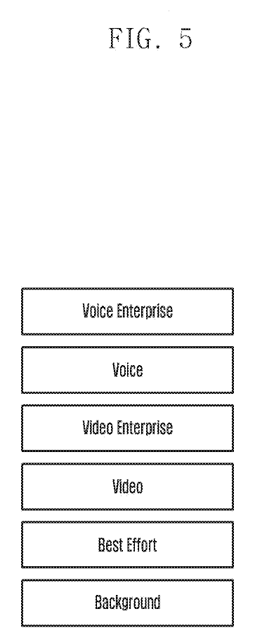

Upon capturing the input traffic, the station (403) identifies the enterprise traffic associated with the enterprise application from the input traffic received. Further, the station (403) categorizes (or, classifies) the enterprise traffic into one or more access categories as shown in FIG. 5.

FIG. 5 is a schematic diagram that illustrates access categories in WMM, according to an embodiment of the disclosure.

For example, the station (403) can categorize (or, classifies) the identified enterprise traffic into voice enterprise traffic and video enterprise traffic. Upon categorizing, the station (403) performs mangling in the header of data packets for the enterprise traffic. The station mangles at least one of a Layer 2 header (Layer 2 is a data link layer), Layer 3 header (Layer 3 is a network layer), and Layer 4 header (Layer 4 is a transport layer) to provide an indication about the presence of the enterprise traffic for the AP (405). Further, the station (403) sends the enterprise traffic to the AP (205).

The AP (405) receives the input traffic from the station (403). Upon receiving the input traffic, the AP (405) identifies the enterprise traffic from the input traffic based on at least one of the mangled L2 header, L3 header, L4 header, and application layer header. Upon identifying the enterprise traffic, the AP (405) prioritizes the enterprise traffic over the non-enterprise traffic for further transmission over the Wi-Fi network. This prioritization ensures that enterprise applications receive the necessary bandwidth and low latency required for optimal performance. Further, the AP (405) restores the legacy L2 header, L3 header, L4 header, and application layer header for the transmission towards the Wi-Fi network. This restoration is used for maintaining compatibility and ensuring that the data packets are correctly processed by subsequent network devices and applications.

FIG. 4B is a block diagram that illustrates a station for managing WiSE in a wireless network according to an embodiment of the disclosure.

The station (403) includes a processor (407), memory (409), an input output (I/O) interface (413), and a WiSE controller (411), a WiSE service (415), an activity manager (417), audio manager (419), and WiSE Mangler (421). Furthermore, the processor (407) of the station (403) communicates with the memory (409), the I/O interface (413), the WiSE controller (411), the WiSE service (415), the activity manager (417), the audio manager (419), and the WiSE Mangler (421). The processor (407) is configured to execute instructions stored in the memory (409) and to perform various processes. The processor (407) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (409) of the station (403) includes storage locations that can be addressed through the processor (407). The memory (409) is not limited to volatile or non-volatile memory and can include one or more computer-readable storage media. Non-volatile storage elements such as magnetic hard disks, optical discs, floppy discs, flash memories, erasable programmable read-only memory (EPROM), or electrically erasable programmable read-only memory (EEPROM) memories can also be included in the memory (409). Further, the memory (409) of the station (403) can store various information received from the AP (405) and context information received from one or more applications associated with the station. This stored information is used by the station's operation, enabling it to manage and prioritize network traffic efficiently, ensuring that enterprise traffic is handled with the necessary priority and security.

The I/O interface (413) transmits information between the memory (409) and external peripheral devices, which are input-output devices associated with the station (403). The I/O interface (413) receives various information from the AP (405) and the one or more applications running in the station (403). This interface is used to maintain seamless communication between the station and external devices, ensuring that data is accurately transmitted and received. Additionally, the I/O interface (413) facilitates the integration of the station with other network components, enhancing its capability to manage WiSE effectively.

The WiSE controller (411) communicates with the I/O interface (413), the memory (409), the WiSE service (415), the activity manager (417), the audio manager (419), and the WiSE Mangler (421) for managing Wi-Fi Slicing for Enterprise Traffic (WiSE) in the wireless network. The WiSE controller (411) is an innovative hardware that is realized through the physical implementation of both analog and digital circuits, including logic gates, integrated circuits, microprocessors, microcontrollers, memory circuits, passive and active electronic components, as well as optical components. Also, the WiSE service (415), the activity manager (417), the audio manager (419), and the WiSE Mangler (421) is realized through the physical implementation of both analog and digital circuits, including logic gates, integrated circuits, microprocessors, microcontrollers, memory circuits, passive and active electronic components, as well as optical components. The WiSE controller (411) of the station (403) receives the input traffic from the one or more applications running. Further, the WiSE controller (411) identifies the enterprise traffic from the input traffic. The WiSE controller (411) identifies the enterprise traffic, fetches the unique identifier (UID) associated with the input traffic, and active processes running from the activity manager (417). For example, the active process can be active application running in the station (403). Also, the WiSE controller (411) fetches the context of the input traffic associated with one or more applications from the audio manager (419). The context refers to conditions or attributes or information about the input traffic. For example, the context can be a source and destination of input traffic, type of traffic (such as access categories like video, voice, or file), protocols used, priority levels and the like. Once the WiSE controller (411) identifies the enterprise traffic from the input traffic based on the UID and the context of the one or more applications, the WiSE service (415) sends the UID of the identified enterprise applications to the WiSE Mangler (421). Further, the WiSE Mangler (421) converts or mangles the DSCP value in the header of the data packets associated with the enterprise traffic to indicate the presence of enterprise traffic to the AP (405). The WiSE mangler (421) mangles the at least one of DSCP value in the L2 header of the data packets to indicate the presence of the enterprise traffic. Also, the WiSE mangler (421) at L3 layer transmits the MSCS or SCS request message to the AP (405) to indicate the presence of the enterprise traffic. In an embodiment, the WiSE mangler (421) mangles the two-bit user priority (UP) control field to indicate the presence of the enterprise traffic. Also, the WiSE service (415) sends the MSCS request to the AP (405) to confirm the presence of the enterprise traffic. In L4 header, the WiSE mangler (421) sets the Type Length Value (TLV) field in TCP options. For example, the WiSE mangler (421) sets a Type as '200' and length bit as '1' and value as '1' to indicate the enterprise traffic.

The integration of these components within the station (403) ensures a robust and efficient system for managing WiSE in a wireless network. The processor (407) and the memory (409) work in tandem to execute and store instructions and data, while the I/O interface (413) ensures seamless communication with external devices. The WiSE controller (411), along with the WiSE service (415), the activity manager (417), the audio manager (419), and the WiSE Mangler (421), collectively manage and prioritize enterprise traffic, ensuring that it is handled with the appropriate level of priority and security. This comprehensive system design allows for effective management of Wi-Fi slicing, providing a reliable and efficient solution for enterprise traffic in a wireless network.

FIG. 4C is a block diagram that illustrates an AP for managing WiSE in a wireless network according to an embodiment of the disclosure.

The AP (405) includes a processor (423), memory (425), an I/O interface (427), and a WiSE controller (429). Furthermore, the processor (423) of the AP (405) communicates with the memory (425), the I/O interface (427), and the WiSE controller (429). The processor (423) is configured to execute instructions stored in the memory (425) and to perform various processes. The processor (423) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (425) of the AP (405) includes storage locations that can be addressed through the processor (423). The memory (425) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (425). Further, the memory (425) of the AP (405) can store various information received from the station (403) such as the mangled DSCP value that indicates the presence of the enterprise traffic and other necessary fields included in the enterprise traffic.

The I/O interface (427) transmits information between the memory (425) and external peripheral devices, which are input-output devices associated with the AP (405). The I/O interface (427) receives various information from the station (403). The various information can include the mangled DSCP value in at least one of the L2 header, L3 header, L4 header, or application layer header that indicates the presence of the enterprise traffic.

The WiSE controller (429) communicates with the I/O interface (427) and the memory (425) for managing WiSE in the wireless network. The WiSE controller (429) is an innovative hardware that is realized through the physical implementation of both analog and digital circuits, including logic gates, integrated circuits, microprocessors, microcontrollers, memory circuits, passive and active electronic components, as well as optical components. The WiSE controller (429) of the station (403) receives the input traffic from the station (403). The input traffic received can include the enterprise traffic and the non-enterprise traffic. Further, the WiSE controller (429) detects the enterprise traffic from the input traffic based on the at least one mangled L2 header, mangled L3 header, mangled L4 header, and mangled application layer header in data packets of the enterprise traffic. Particularly, the AP (405) determines mangled DSCP value in the at least one of the mangled L2 header, the mangled L3 header, the mangled L4 header, and the mangled application layer header. Particularly, the WiSE controller (429) identifies the mangled DSCP value in the L3 header to recognize the traffic being the enterprise traffic. Similarly, the WiSE controller (429) identifies the mangled DSCP value by receiving the MSCS or SCS request message at L3 layer. Also, the WiSE controller (429) identifies the mangled DSCP value based on the two-bit UP control field set in the L2 header. Also, the WiSE controller (429) identifies enterprise traffic based on the modification performed in the L4 header and introduction of the new header at the application layer. The new header is a custom header with one bit field that provides an indication for the enterprise traffic. Once the mangled DSCP value is identified in the header, the WiSE controller (429) prioritizes the corresponding data packets for providing the Wi-Fi service. Further, the WiSE controller (429) restores the at least one of the legacy L2 header, the legacy L3 header, the legacy L4 header, and the legacy application layer for the enterprise traffic.

The proposed solution allows the WiSE controller (429) to efficiently manage and prioritize enterprise traffic, ensuring that data packets receive the bandwidth and low-latency treatment required for optimal performance. By distinguishing between enterprise and non-enterprise traffic, the WiSE controller (429) can allocate network resources more effectively, preventing congestion and ensuring a seamless user experience. The restoration of the legacy headers is used for maintaining compatibility with existing network protocols and infrastructure, allowing for smooth integration and operation within diverse network environments.

Further, the integration of both analog and digital circuits within the WiSE controller (429) illustrates the advanced engineering involved in its design. The use of logic gates, microprocessors, and microcontrollers enables the controller to perform complex data processing tasks with high efficiency. Memory circuits and both passive and active electronic components ensure that the controller can store and retrieve data swiftly, while optical components may enhance data transmission speeds and reliability.

By accurately identifying and prioritizing enterprise traffic, the controller can implement advanced security measures to protect sensitive data. The ability to detect and manage mangled headers ensures that the controller can identify potential threats and anomalies in the wireless network traffic, providing an additional layer of security. The WiSE controller (429) thus not only improves network performance but also contributes to the overall security and integrity of enterprise communications.

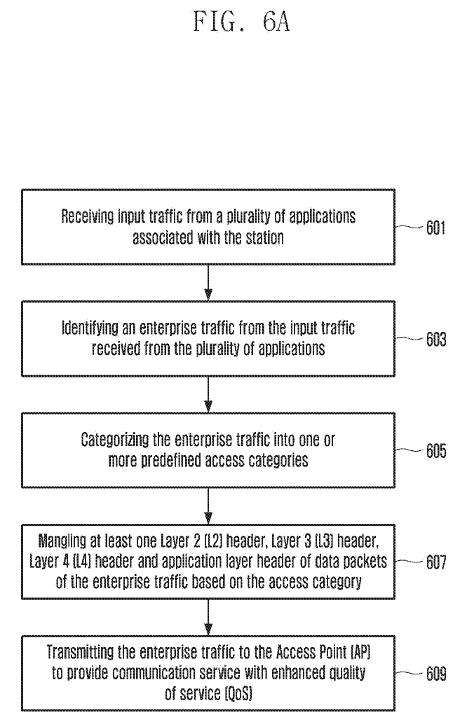

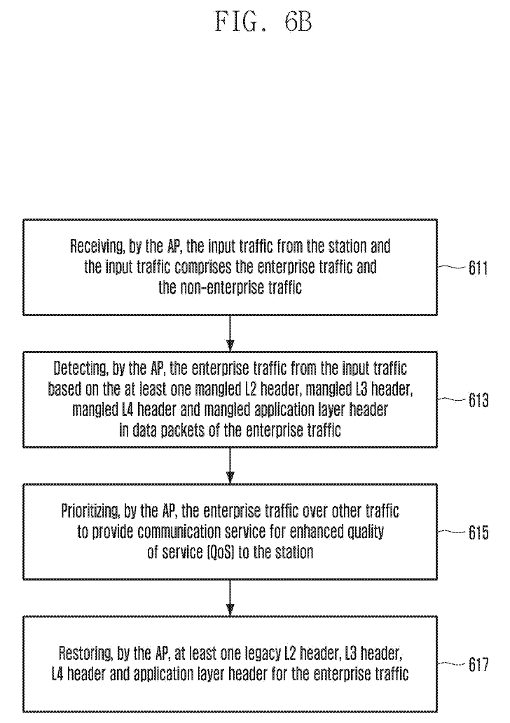

FIGS. 6A and 6B are flow diagrams that illustrates a method for managing WiSE in a wireless network according to various embodiments of the disclosure.

Referring to FIG. 6A, at block 601, the method includes receiving by the station (403) input traffic from the plurality of applications associated with the station (403). The plurality of applications can be at least one of the enterprise application or non-enterprise application.

At block 603, the method includes identifying by the station (403) the enterprise traffic from the input traffic. The enterprise traffic is associated with at least one of the enterprise applications. Particularly, the station (403) captures the UID of the at least one actively running application and the context related to the actively running applications. Further, the station (403) identifies the enterprise traffic based on the UID of the application and the context related to the application. This identification is used for segregating enterprise traffic from non-enterprise traffic, enabling the system to apply specific policies and prioritizations.

At block 605, the method includes categorizing (or, classifying) by the station (403) the enterprise traffic into one or more access categories such as voice, video, best-effort, Time-Sensitive Networking (TSN), and background. This categorization is significant as different types of traffic have varying requirements for bandwidth, latency, and reliability. For instance, voice and video traffic typically require low latency and high reliability, whereas background traffic can tolerate delays. By categorizing the traffic, the station (403) can apply appropriate QoS policies to meet the specific needs of each traffic type.

At block 607, the method includes mangling (or, set, configure, modify, change) by the station (403) at least one Layer 2 (L2) header, Layer 3 (L3) header, Layer 4 (L4) header, and application layer header of data packets of the enterprise traffic based on the access category. At the L2 layer, the station (403) mangles the DSCP field in the IP header of the data packets of the enterprise traffic. The station (403) sets the DSCP value in the ToS field to a value to indicate that the data packets belong to the enterprise traffic and need to be prioritized. In an embodiment, at the L2 layer, the station (403) can set a two-bit value in the user priority (UP) control field in the L2 header that indicates that the data packets are of the enterprise application. Particularly, the two reserved bits of the UP control field are used to provide the indication of the enterprise traffic. For example, the two reserved bits in the UP control field can be set to 01, 10, or 11 to indicate the enterprise traffic. For example, at least one of the mangled L2 header, mangled L3 header, mangled L4 header and mangled application layer header corresponds to Pool B (or, Pool 2). This mangling method ensures that the enterprise traffic is marked appropriately for prioritization throughout the wireless network.

In an embodiment, at the L3 layer, the station (403) transmits at least one of the MSCS and SCS request messages to the AP (405) to indicate or confirm that the DSCP value is mangled, indicating the presence of the enterprise traffic. At block 609, the method includes transmitting by the station (403) the input traffic to the AP (405) to provide communication service with enhanced QoS. This operation ensures that the AP (405) is aware of the enterprise traffic and can handle it accordingly.

Referring to FIG. 6B, at block 611, the method includes receiving by the AP (405) the input traffic from the station (403) for providing the Wi-Fi service. The input traffic received from the station (403) includes both enterprise traffic and non-enterprise traffic. At block 613, the method includes detecting by the AP (405) the enterprise traffic from the input traffic based on the at least one of the mangled L2 header, the mangled L3 header, the mangled L4 header, and the mangled application layer header. Particularly, the AP (405) reads the DSCP bit value in the ToS field of the IP header and performs an AND operation between the DSCP bit value and 000011. Upon performing the AND operation, the AP (405) determines whether the resultant obtained is 11. Further, the AP (405) detects the input traffic as the enterprise traffic when the resultant of the AND operation is 11. However, the AP (405) detects the input traffic as non-enterprise traffic when the resultant obtained is not 11. This detection mechanism allows the AP (405) to distinguish between different types of traffic and apply the appropriate QoS policies.

At block 615, the AP (405) prioritizes the enterprise traffic over the other input traffic to provide the Wi-Fi service or communication service with enhanced QoS to the station (403). This prioritization ensures that the enterprise applications receive the network resources to function optimally, thereby improving overall network performance and user experience. At block 617, the AP (405) restores the at least one legacy L2 header, legacy L3 header, legacy L4 header, and legacy application layer header for the prioritized enterprise traffic. Particularly, the AP (405) converts the enterprise traffic from Pool B to Pool A to restore the at least one legacy L2 header, legacy L3 header, legacy L4 header, and legacy application layer header. Upon restoring, the AP (405) transmits the enterprise traffic to the Wi-Fi network to provide the Wi-Fi service for the station (403) with enhanced QoS. This restoration method ensures that the data packets are in the correct format for transmission across the wireless network, maintaining compatibility with existing network infrastructure and protocols.

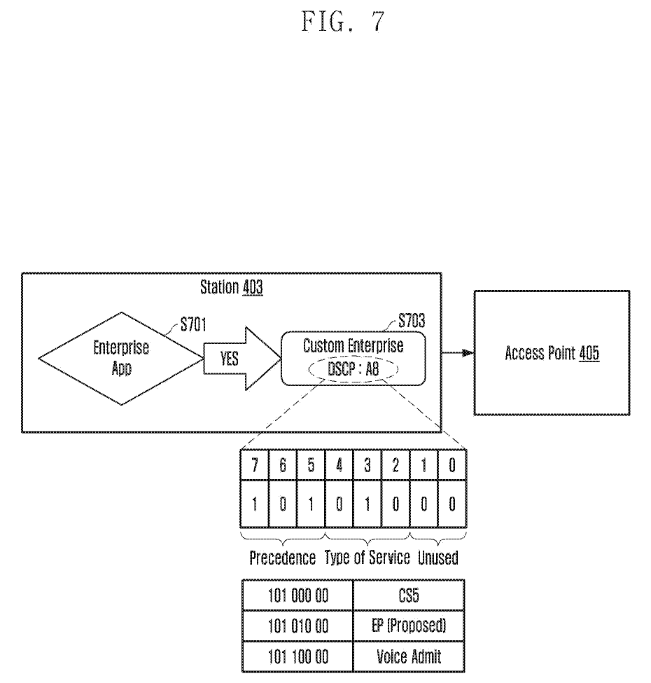

FIG. 7 is a schematic diagram that illustrates a method of mangling of DSCP value in the Layer 3 header of data packets to indicate the presence of enterprise traffic according to an embodiment of the disclosure.

The proposed solution is used for distinguishing enterprise traffic from other types of traffic, thereby enabling network devices to prioritize and manage data flow more effectively. The mangling of the DSCP value serves as a marker that can be recognized by various network components to ensure that enterprise traffic receives the appropriate level of service and security.

Referring to FIG. 7, at operation S701, the station (403) determines whether the input traffic from the plurality of applications is enterprise traffic based on the UID of the application and the context of the application. This determination involves analyzing the unique identifier (UID) associated with the applications to ascertain its nature and purpose. The context of the application, which may include factors such as the type of data being transmitted, the destination, and the application's role within the enterprise network, is also considered. By leveraging these parameters, the station (403) can accurately classify the traffic as enterprise traffic or otherwise.

At operation S703, the station (403) mangles (or, configure, set, modify, change) the DSCP value in the ToS field, indicating that the traffic is enterprise traffic when the input traffic is determined to be enterprise traffic. The station (403) specifically modifies the 8-bit DSCP value (0-7) to indicate the presence of enterprise traffic. In particular, the station (403) alters the 3-bit ToS field to have the value 010, signaling that the traffic is enterprise-related. This modification ensures that the enterprise traffic is easily identifiable by downstream network devices, which can then apply the QoS policies to prioritize this traffic.

In an embodiment, the station (403) defines at least one of two or multi-level DSCP values based on the application context. For example, a particular DSCP value can be set for foreground processes, which are typically more time-sensitive and require higher priority, and a different DSCP value can be set for background processes, which may be less time-sensitive and can tolerate lower priority. This multi-level DSCP value assignment allows for more granular control over the prioritization of enterprise traffic, ensuring that enterprise applications receive the bandwidth and low latency they require, while non-enterprise applications are appropriately managed. For example, the DSCP value is 32' ToS field value is 80 for regular real time traffic, and the DSCP value is 32 ToS field value is 82 for the enterprise real time traffic. Similarly, the DSCP value is set as 40 with ToS 160 for regular voice traffic and the DSCP value is set as 40' with ToS 162 for enterprise voice traffic.

At operation S705, the station (403) transmits the enterprise traffic to the AP (405). The AP (405) then identifies the enterprise traffic based on the DSCP value mangled in the IP header of the data packet. This identification enables the AP (405) to apply specific handling rules to the enterprise traffic, such as prioritizing it over other types of traffic, ensuring it is routed through secure channels, or allocating additional resources to maintain its quality of service. By effectively managing enterprise traffic in this manner, the wireless network can provide a more reliable and efficient service to enterprise applications, enhancing overall network performance and user experience.

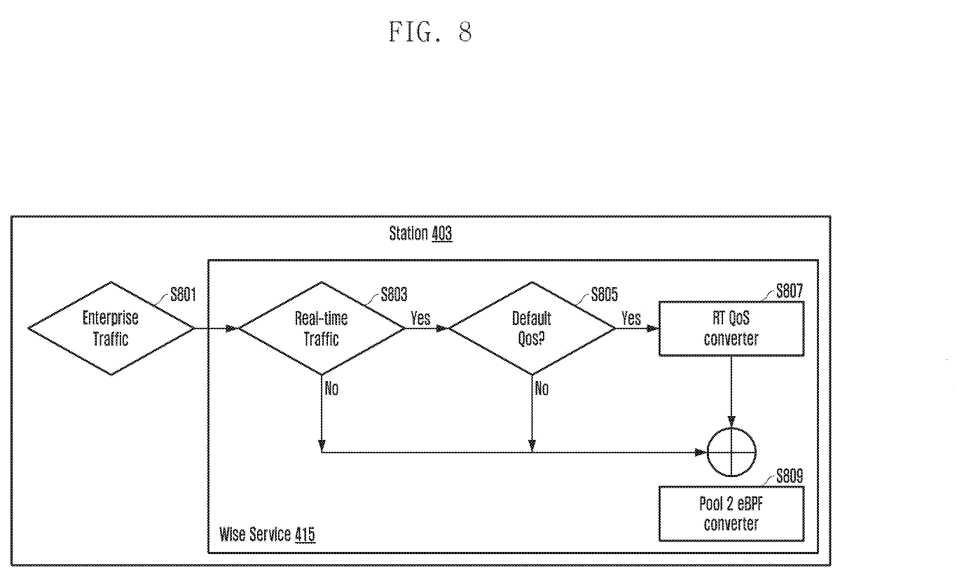

FIG. 8 is a schematic diagram that illustrates a method of multi-level DSCP mapping according to an embodiment of the disclosure.

Referring to FIG. 8, t operation S801, the station (403) determines whether the input traffic is enterprise traffic based on the UID and context of the plurality of applications associated with the input traffic. The determination leverages the UIDs and contextual information, which may include application types, user roles, and other metadata that help in classifying the traffic accurately.

At operation S803, the station (403) determines whether the identified enterprise traffic is real-time traffic. The determination of real-time traffic helps to identify the type of traffic that requires higher prioritization due to its sensitivity to latency and jitter. This operation can be performed using an artificial intelligence (AI) model, which analyzes patterns and characteristics of the traffic to make an informed decision. The AI model can be trained on historical data to recognize real-time traffic, such as VoIP calls or live video streams, ensuring that these data streams are given the priority.

At operation S805, the station (403) assesses whether the enterprise traffic includes default QoS information or a specific range of DSCP values when it is determined to be real-time traffic at S803. This step involves examining the QoS parameters embedded within the traffic to ascertain if they meet predefined criteria. If the real-time traffic includes default QoS information or falls within a specific DSCP value range, it indicates that the traffic has been pre-configured for quality standards.

At operation S807, the station (403) converts the DSCP value to the RT DSCP value when the enterprise traffic includes the default QoS information or a specific range of DSCP values. This conversion is used to align the traffic with the appropriate QoS level required for real-time communication. By mapping the DSCP value to the RT DSCP value, the system ensures that real-time traffic is handled with the highest priority, minimizing delays and maintaining the integrity of the data stream.

At operation S809, the station (403) converts the enterprise traffic from Pool A to Pool B or from Pool 1 to Pool 2 when the enterprise traffic is not real-time traffic at S803 or when the enterprise traffic does not include the QoS information or a specific range of DSCP values at S805. This operation involves reclassifying non-real-time traffic or traffic lacking specific QoS parameters into different pools. Pool A and Pool B (or Pool 1 and Pool 2) represent different priority levels or handling mechanisms within the wireless network. By reallocating the traffic, the system ensures that resources are optimally utilized, and non-enterprise traffic does not interfere with high-priority data streams.

The operations S803-S807 can be performed using an AI model. For example, the AI model can be, but not limited to a neural network model, an eXtreme Gradient Boosting (XGBoost) model and a transformer model.

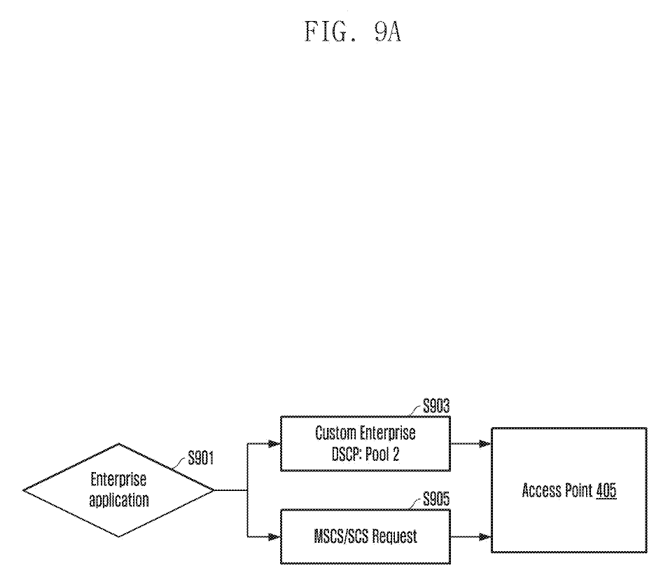

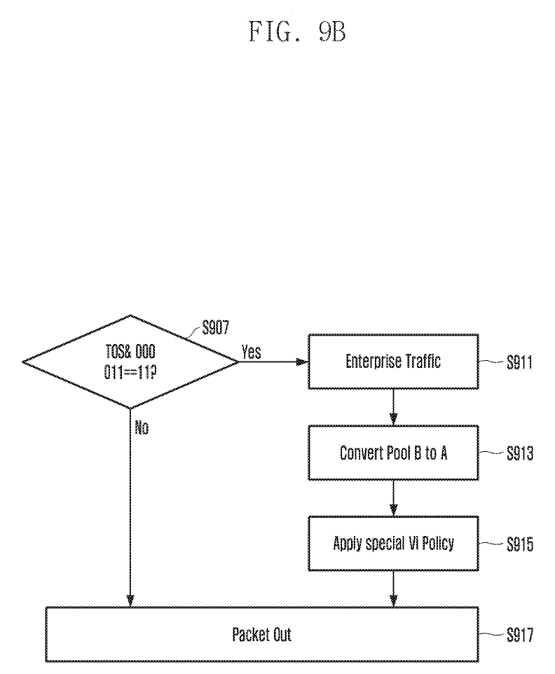

FIG. 9A is a schematic diagram that illustrates the method of sending an MSCS/SCS message indicating the presence of enterprise traffic according to an embodiment of the disclosure.

Referring to FIG. 9A, at operation S901, the station (403) determines whether the input traffic is enterprise traffic based on the UID and context of the plurality of applications associated with the input traffic. This determination is used for ensuring that enterprise traffic, which often requires higher priority and better QoS, is appropriately identified and managed. The station (403) utilizes specific identifiers and contextual information to accurately classify the traffic, thereby enabling more efficient network resource allocation.

At operation S903, once the input traffic is determined to be enterprise traffic, the station (403) mangles the DSCP value in the ToS field to indicate the traffic as enterprise traffic. Specifically, the station (403) modifies the 8-bit DSCP value (ranging from 0 to 7) to reflect this classification. In particular, the station (403) alters the 3-bit ToS field to have the value 010, which signifies that the traffic is enterprise traffic. This mangling method ensures that the traffic is marked appropriately for subsequent handling by the wireless network infrastructure. Following this modification, the enterprise traffic is sent to the AP (405), ensuring that it is flagged for treatment as it traverses the wireless network.

At operation S905, the station (403) sends at least one MSCS/SCS request message to the AP (405), indicating the presence of enterprise traffic. This message serves as a notification to the AP (405) that the incoming traffic is treated with higher priority. The MSCS/SCS request message includes details that help the AP (405) identify and prioritize the enterprise traffic, ensuring that it receives the QoS enhancements.

FIG. 9B is a schematic diagram that illustrates the method of identifying and prioritizing enterprise traffic at the AP according to an embodiment of the disclosure.

Referring to FIG. 9B, at operation S907, the AP (405) receives the input traffic from the station (403) and identifies whether the input traffic includes enterprise traffic. To accomplish this, the AP (405) reads the 3-bit value in the ToS field and performs an AND operation with the bit value 000. This logical operation helps the AP (405) determine if the resultant value is 11, which indicates the presence of enterprise traffic.

At operation S911, the AP (405) determines that the input traffic is enterprise traffic when the resultant value of the AND operation is 11. This identification method is used for ensuring that enterprise traffic is correctly recognized and handled. Once identified, at operation S913, the AP (405) converts the enterprise traffic from Pool B to Pool A. This conversion signifies a transition from a lower priority pool to a higher priority pool, reflecting the need for enhanced QoS for enterprise traffic.

At operation S915, the AP (405) applies a policy for prioritizing the enterprise traffic, thereby providing the Wi-Fi service to the station (403) with enhanced QoS. This policy may include various QoS mechanisms such as traffic shaping, prioritization, and bandwidth allocation to ensure that enterprise traffic receives the resources for optimal performance. Finally, at operation S917, the AP (405) sends the enterprise traffic to the Wi-Fi network, ensuring that the station (403) receives the Wi-Fi service with the enhanced QoS. This comprehensive method ensures that enterprise traffic is efficiently managed and prioritized, providing a seamless and high-quality experience for enterprise applications.

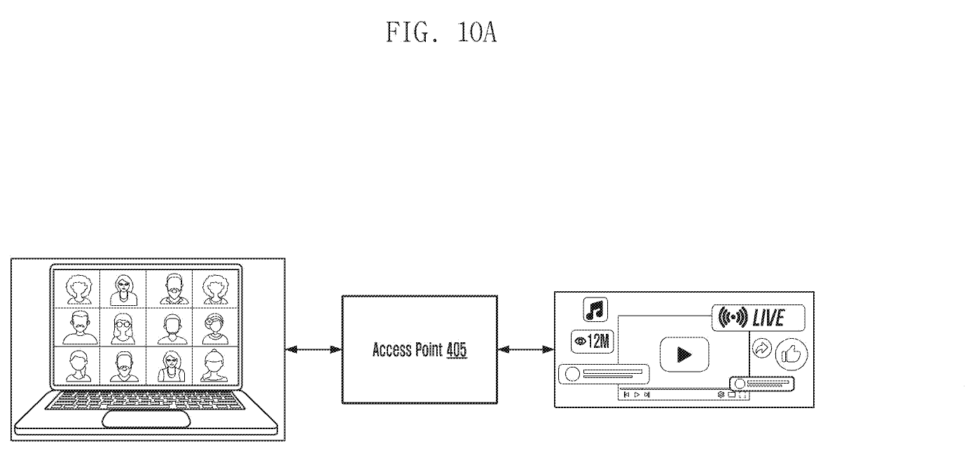

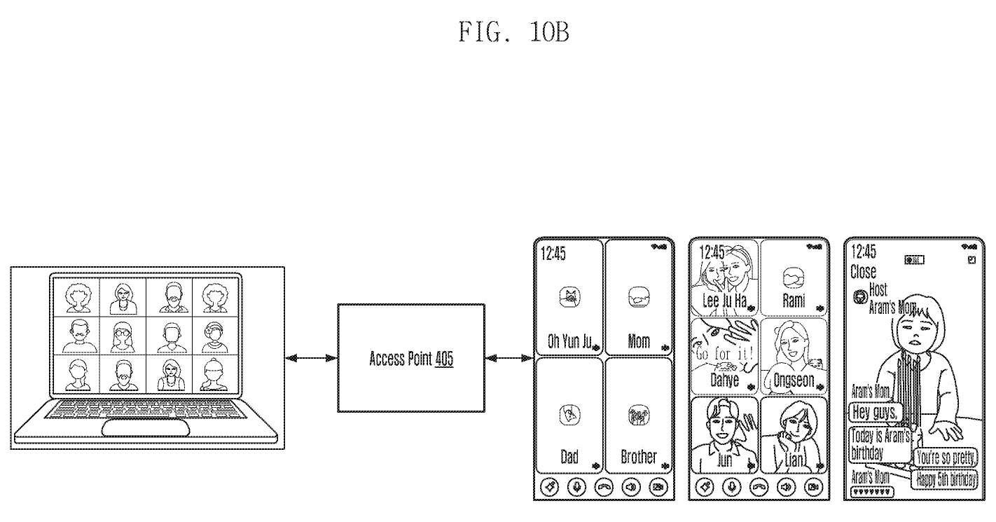

FIGS. 10A and 10B are schematic diagrams that illustrate an example scenario of prioritizing enterprise traffic at the AP (405) according to various embodiments of the disclosure.

In the example scenario, consider that the AP (405) receives input traffic from the station (403).

Referring to FIG. 10A, the input traffic includes the enterprise traffic associated with the enterprise application (Office meeting in Microsoft Teams or Google Meet) running in the first station. Additionally, the input traffic includes non-enterprise traffic associated with non-enterprise applications such as YouTube gaming applications and the like running in the second station. The first station mangles the DSCP value in the header for the enterprise traffic; however, the second station does not mangle the DSCP value. The AP (405) identifies the mangled header in the input traffic received from the first station and recognizes that the traffic received from the first station is enterprise traffic. Consequently, the AP (405) prioritizes the enterprise traffic over the input traffic received from the second station. Furthermore, the AP (405) converts the enterprise traffic from Pool B to Pool A and transmits it over the Wi-Fi network to provide enhanced QoS for the first station that runs the enterprise application.

Similarly, referring to FIG. 10B, the AP (405) receives input traffic from the station (403). For example, as shown in FIG. 10B, the input traffic includes enterprise traffic associated with the enterprise application (Office meeting in Microsoft Teams or Google Meet) running in the first station. Additionally, the input traffic includes non-enterprise traffic associated with non-enterprise applications such as a video call application where the video call is a personal video call running in the second station. The first station mangles the DSCP value in the header for the enterprise traffic. The second station does not mangle the DSCP value. The AP (405) identifies the mangled header in the input traffic received from the first station and recognizes that the traffic received from the first station is enterprise traffic. Consequently, the AP (405) prioritizes the enterprise traffic over the input traffic received from the second station. Furthermore, the AP (405) converts the enterprise traffic from Pool B to Pool A and transmits it over the Wi-Fi network to provide enhanced QoS for the first station that runs the enterprise application.

In both scenarios depicted in FIGS. 10A and 10B, the prioritization mechanism employed by the AP (405) ensures that enterprise applications receive a higher level of service quality compared to non-enterprise applications. By identifying and prioritizing enterprise traffic, the AP (405) effectively manages network resources to minimize latency, reduce packet loss, and ensure a seamless user experience for enterprise applications. This approach enhances productivity and optimizes the overall performance of the Wi-Fi network by dynamically allocating resources based on the type of traffic and its associated requirements.

Further, the ability of the AP (405) to distinguish between mangled and non-mangled DSCP values allows for a more granular level of traffic management. Enterprises can configure their devices to mangle DSCP values for specific applications, thereby signaling to the AP (405) the importance of the traffic. This method provides a flexible and scalable solution for managing diverse types of network traffic, ensuring that enterprise applications are given precedence over non-enterprise applications. As a result, organizations can maintain high standards of communication and collaboration, even in congested network environments, by leveraging the intelligent traffic prioritization capabilities of the AP (405).

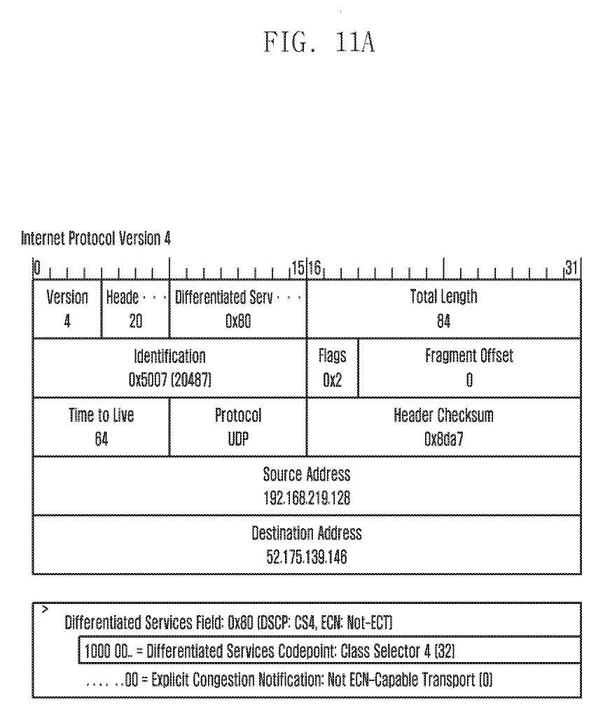

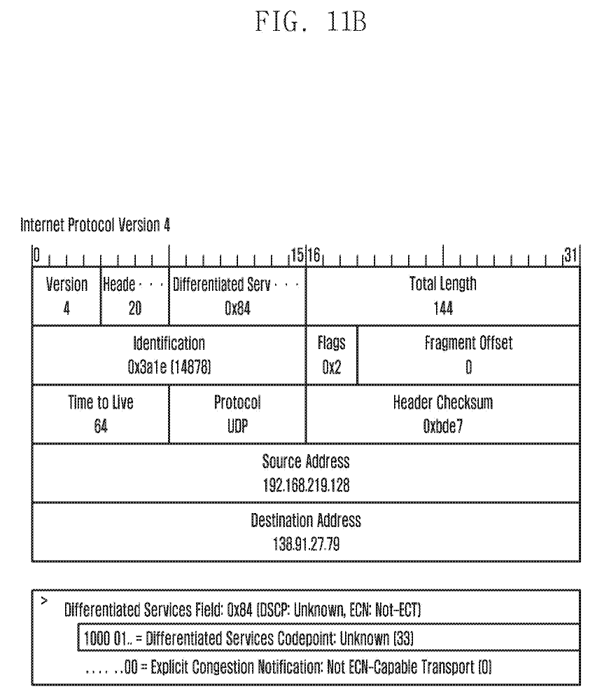

FIG. 11A is a schematic diagram that illustrates an IP header structure indicating the DSCP value in the ToS field for data packets of non-enterprise traffic according to an embodiment of the disclosure.

Referring to FIG. 11A, the DSCP value is used to mark the priority of the packet within the network, allowing routers and switches to handle the packet according to its designated priority level. Non-enterprise traffic typically includes general internet usage such as web browsing, streaming, and personal communications, which may not require stringent QoS guarantees. The DSCP value in the ToS field helps network devices to differentiate and manage this type of traffic efficiently, ensuring that network resources are allocated appropriately without compromising the performance of the enterprise traffic.

FIG. 11B is a schematic diagram that illustrates an IP header structure indicating the DSCP value in the ToS field for data packets of enterprise traffic according to an embodiment of the disclosure.

Enterprise traffic generally includes mission-critical applications such as VoIP, video conferencing, and business-critical data transfers that require higher levels of QoS. The DSCP value in the ToS field for enterprise traffic is set to reflect the higher priority and stricter QoS requirements. This ensures that enterprise traffic receives preferential treatment over non-enterprise traffic, minimizing latency, jitter, and packet loss, which are crucial for maintaining the performance and reliability of business operations.

The differentiation between non-enterprise and enterprise traffic through the DSCP value in the ToS field is a fundamental aspect of modern network management. By appropriately marking packets, network administrators can implement policies that prioritize traffic based on its importance and required service levels. This approach not only optimizes the overall network performance but also enhances the user experience by ensuring that critical applications receive the necessary bandwidth and low-latency paths. The schematic diagrams in FIGS. 11A and 11B provide a clear visual representation of how DSCP values are embedded within the IP header, for effective traffic management in diverse networking environments.

The various actions, acts, blocks, operations, or the like in the method are performed in the order presented, in a different order, or simultaneously. Furthermore, in some embodiments, some of the actions, acts, blocks, operations, or the like are omitted, added, modified, skipped, or the like without departing from the scope of the proposed method.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing wireless-fidelity (Wi-Fi) Slicing for Enterprise Traffic (WiSE) in a wireless network, the method comprising:
receiving, by a station, an input traffic from a plurality of applications associated with the station;
identifying, by the station, an enterprise traffic within the input traffic received from the plurality of applications associated with the station, wherein the enterprise traffic is related to at least one enterprise application of the plurality of applications associated with the station;
classifying, by the station, the enterprise traffic into one or more access categories;
configuring, by the station, at least one of a Layer 2 (L2) header, a Layer 3 (L3) header, a Layer 4 (L4) header, or an application layer header in data packets of the enterprise traffic based on the access categories; and
transmitting, by the station, the configured enterprise traffic to an Access Point (AP) to provide a communication service with enhanced Quality of Service (QoS).

2. The method of claim 1, further comprising:
receiving, by the AP, the input traffic from the station, wherein the input traffic comprises the configured enterprise traffic and non-enterprise traffic;
detecting, by the AP, the configured enterprise traffic within the input traffic based on the configured at least one of the L2 header, the L3 header, the L4 header, or the application layer header in the data packets of the enterprise traffic;
prioritizing, by the AP, the detected enterprise traffic over the non-enterprise traffic to provide the communication service for the enhanced QoS to the station; and
restoring, by the AP, at least one of a legacy L2 header, a legacy L3 header, a legacy L4 header, or a legacy application layer header to the prioritized enterprise traffic.

3. The method of claim 1, wherein the identifying, by the station, of the enterprise traffic within the input traffic received from the plurality of applications comprises:
determining, by the station, a unique identifier (UID) of the plurality of applications and a context related to the plurality of applications; and
identifying, by the station, the enterprise traffic associated with the enterprise application based on the UID and the context related to the at least one enterprise application of the plurality of applications associated with the station.

4. The method of claim 1, wherein the configuring, by the station, of the L2 header in the data packets of the enterprise traffic based on the access categories comprises:
setting, by the station, a Differentiated Service Code Point (DSCP) value in a Type of Service (ToS) field in the L2 header that is indicative of the enterprise traffic within the input traffic; and
sending, by the station, at least one of a Mirrored Stream Classification Service (MSCS) request message or a Stream Classification Service (SCS) request message to the AP for confirming presence of the enterprise traffic.

5. The method of claim 1, wherein the configuring, by the station, of the L3 header in the data packets of the enterprise traffic based on the access categories comprises:
setting, by the station, a Differentiated Service Code Point (DSCP) value in a Type of Service (ToS) field in the L3 header that is indicative of the enterprise traffic within the input traffic.

6. The method of claim 1, wherein the configuring, by the station, of the L2 header in the data packets of the enterprise traffic based on the access categories comprises:
setting, by the station, a two-bit value in a User Priority (UP) control field in the L2 header that is indicative of the enterprise traffic within the input traffic.

7. The method of claim 1, wherein the configuring, by the station, of the L4 header in the data packets of the enterprise traffic based on the access categories comprises:
modifying, by the station, Transmission Control Protocol (TCP) options in the L4 header that are indicative of the enterprise traffic within the input traffic.

8. The method of claim 1, wherein the configuring, by the station, of the application layer header in the data packets of the enterprise traffic based on the access category comprises:
adding, by the station, a new header in the application layer that comprises one or more fields which are indicative of the enterprise traffic within the input traffic.

9. The method of claim 2, wherein the detecting, by the AP, of the configured enterprise traffic within the input traffic based on the configured at least one of the L2 header, the L3 header, the L4 header, or the application layer header in the data packets of the enterprise traffic comprises:
performing, by the AP, at least one of:
identifying a Differentiated Service Code Point (DSCP) value in the L3 header that is indicative of the enterprise traffic, or
receiving at least one of a Mirrored Stream Classification (MSCS) request message or a Stream Classification Service (SCS) request message that indicates the configuring of the DSCP value in the L3 header; or
identifying a two-bit value in a User Priority (UP) control field in the L2 header that is indicative of the enterprise traffic, or
detecting modification performed in the L4 header that is indicative of the enterprise traffic, or
identifying the application layer header that is indicative of the enterprise traffic; and
based on the performing, detecting, by the AP, the configured enterprise traffic within the input traffic based on the configured at least one of the L2 header, the L3 header, the L4 header and the application layer header in data packets of the enterprise traffic.

10. The method of claim 1, wherein the one or more access categories are voice, video, best-effort, Time-Sensitive Networking (TSN) and background.

11. A station in a wireless-fidelity (Wi-Fi) system for managing Wi-Fi Slicing for Enterprise Traffic (WiSE) in a wireless network, the station comprising:
an input output (I/O) interface configured to receive and transmit a signal;
one or more processors communicatively coupled to the I/O interface;
memory, comprising one or more storage media, storing one or more computer programs, the memory being communicatively coupled to the I/O interface and the one or more processors; and
a WiSE controller communicatively coupled to the I/O interface, the one or more processors, and the memory,
wherein the one or more computer programs include computer-executable instructions that, when executed by the one or more processors individually or collectively, cause the WiSE controller to:
receive an input traffic from a plurality of applications associated with the station,
identify an enterprise traffic within the input traffic received from the plurality of applications associated with the station, wherein the enterprise traffic is related to at least one enterprise application of the plurality of applications associated with the station,
classify the enterprise traffic into one or more access categories,
configure at least one of a Layer 2 (L2) header, a Layer 3 (L3) header, a Layer 4 (L4) header, or an application layer header in data packets of the enterprise traffic based on the access categories, and
transmit the configured enterprise traffic to an Access Point (AP) to provide a communication service with enhanced Quality of Service (QoS).

12. The station of claim 11, wherein the AP comprises:
a second I/O interface configured to receive and transmit the signal;
second one or more processors communicatively coupled to the second I/O interface;
second memory, comprising second one or more storage media, storing second one or more computer programs, the second memory being communicatively coupled to the second I/O interface and the second one or more processors; and
a second WiSE controller communicatively coupled to the second I/O interface, the second one or more processors, and the second memory,
wherein the second one or more computer programs include second computer-executable instructions that, when executed by the second one or more processors individually or collectively, cause the second WiSE controller to:
receive the input traffic from station, wherein the input traffic comprises the configured enterprise traffic and non-enterprise traffic,
detect the configured enterprise traffic within the input traffic based on the configured at least one of the L2 header, the L3 header, the L4 header, or the application layer header in the data packets of the enterprise traffic,
prioritize the detected enterprise traffic over the non-enterprise traffic to provide the communication service for the enhanced QoS to the station, and
restore at least one of a legacy L2 header, a legacy L3 header, a legacy L4 header, or a legacy application layer header to the prioritized enterprise traffic.

13. The station of claim 11, wherein the computer-executable instructions that, when executed by the one or more processors individually or collectively, cause the WiSE controller to identify the enterprise traffic from within the input traffic received from the plurality of applications further cause the WiSE controller to:
determine a unique identifier (UID) of the plurality of applications and a context related to the plurality of applications; and
identify the enterprise traffic associated with the enterprise application based on the UID and the context related to the at least one enterprise application of the plurality of applications associated with the station.

14. The station of claim 11, wherein the computer-executable instructions that, when executed by the one or more processors individually or collectively, cause the WiSE controller to configure the L2 header in the data packets of the enterprise traffic based on the access categories further cause the WiSE controller to:
set a Differentiated Service Code Point (DSCP) value in a Type of Service (ToS) field in the L3 header that is indicative of the enterprise traffic within the input traffic; and
send at least one of a Mirrored Stream Classification Service (MSCS) request message or a Stream Classification Service (SCS) request message to the AP for confirming presence of the enterprise traffic.

15. The station of claim 11, wherein the computer-executable instructions that, when executed by the one or more processors individually or collectively, cause the WiSE controller to configure the L3 header in the data packets of the enterprise traffic based on the access categories further cause the WiSE controller to:
set a Differentiated Service Code Point (DSCP) value in a Type of Service (ToS) field in the L3 header that is indicative of the enterprise traffic within the input traffic.

16. The station of claim 11, wherein the computer-executable instructions that, when executed by the one or more processors individually or collectively, cause the WiSE controller to configure the L2 header in the data packets of the enterprise traffic based on the access categories further cause the WiSE controller to:
set a two-bit value in User Priority (UP) control field in the L2 header that is indicative of the enterprise traffic within the input traffic.

17. The station of claim 11, wherein the computer-executable instructions that, when executed by the one or more processors individually or collectively, cause the WiSE controller to configure the L4 header in the data packets of the enterprise traffic based on the access categories further cause the WiSE controller to:
modify Transmission Control Protocol (TCP) options in the L4 header that are indicative of the enterprise traffic within the input traffic.

18. The station of claim 11, wherein the computer-executable instructions that, when executed by the one or more processors individually or collectively, cause the WiSE controller to configure the application layer header in the data packets of the enterprise traffic based on the access category further cause the WiSE controller to:
add a new header in the application layer that comprises one or more fields which are indicative of the enterprise traffic within the input traffic.

19. The station of claim 11, wherein the one or more computer programs comprise an artificial intelligence (AI) model comprising at least one of a neural network model, an eXtreme Gradient Boosting (XGBoost) model, or a transformer model.

20. The station of claim 19, wherein the AI model is a trained AI model that has been trained on historical data.
